(19) United States
(12) Patent Application Publication
(10) Pub. No.: US 2014/0283126 A1
(43) Pub. Date: Sep. 18, 2014

(54) Managing Privacy For User-Generated Lists In An Online System

(71) Applicant: Facebook, Inc., Menlo Park, CA (US)

(72) Inventor: Samuel Lessin, Palo Alto, CA (US)

(21) Appl. No.: 13/842,137

(22) Filed: Mar. 15, 2013

(51) Int. Cl. G06F 21/62

(52) U.S. Cl. CPC G06F 21/6218
USPC 726/28

(57) ABSTRACT

A user of a social networking system creates a list of objects and associates the list with a list privacy level identifying the list's accessibility to other social networking system users. For example, the list privacy level indicates other social networking system users capable of accessing the list. For example, a user creates a list including other users and associates a list privacy level with the list. Hence, the user may specify a privacy level of subsequently posted content so that users included on the list, but not other users, may access the posted content.

### BACKGROUND

The present invention relates generally to online systems and more particularly to managing privacy for user-generated lists in an online system.

In recent years, online systems, particularly social networking systems, have made it easier for users to share their interests and preferences in real-world concepts, such as their favorite movies, musicians, celebrities, soft drinks, hobbies, sports teams, and activities. These interests may be declared by users in user profiles and may also be inferred by social networking systems. Users may also interact with these real-world concepts through multiple communication channels on social networking systems. For example, users interact with pages on the social networking system, share interesting articles about causes and issues with other users on the social networking system, and comment on actions generated by other users on objects external to the social networking system. Additionally, a social networking system notifies users of actions performed on objects external to the social networking system by other users. Social networking system users also frequently search for various phrases in the social networking system, such as their favorite celebrities, restaurants, karaoke bars, or other content.

Users of the social networking system may also generate lists of objects maintained by the social networking system, such as content item posts, users, entities, pages, groups, events, and applications in the social networking system. This allows users to more rapidly access objects included in a list. However, user-generated lists often have inflexible and static privacy settings that limit the lists' accessibility to their creating users. Hence, in conventional social networking systems, users are unable to access lists created by other social networking system users. This inability of other users to access the content of a list created by a social networking system user may increase the difficulty of the other users to access objects included on the list, reducing interaction with the objects included on the lists.

### SUMMARY

A user of a social networking system creates a list of objects and associates a privacy level with the list identifying accessibility of the list to other social networking system users. For example, the privacy level indicates the accessibility of objects on the list to other social networking system users. For example, a user creates a list including other users (“members” of the list) and associates a list privacy level with the list. Hence, the user may specify a privacy level of subsequently posted content so that members of the list may access the posted content. However, the accessibility of other users to the list is regulated by the list privacy level, limiting the ability of additional users to view the list. In one embodiment, notifications are sent to members of the list when a new member is added to the list.

### BRIEF DESCRIPTION OF THE DRAWINGS

FIG. 1 is a high-level block diagram of a process of managing privacy for user-generated lists in a social networking system, according to one embodiment.

FIG. 2 is a high-level block diagram of a system for managing privacy for user-generated lists in a social networking system, according to one embodiment.

FIG. 3 is a flow chart describing a process of publishing content items using privacy levels of user-generated lists in a social networking system, according to one embodiment.

FIG. 4 depicts an example screenshot of a process for managing privacy of user-generated lists in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of a Social Networking System

A social networking system offers its users the ability to communicate and interact with other users of the social networking system. Users join the social networking system and add connections to a number of other users to whom they desire to be connected. Additionally, users of social networking system provide information describing themselves that is stored by the social networking system as user profiles. For example, users may provide their age, gender, geographical location, education history, employment history, or other suitable information to the social networking system. The information provided by users may be used by the social networking system to direct information to the user. For example, the social networking system may recommend social groups, events, and potential friends to a user. The social networking system may also enable users to explicitly express interest in one or more concepts, such as celebrities, hobbies, sports teams, books, and music. These interests may be used in a myriad of ways, including targeting advertisements and selecting relevant stories for a user about other users of the social networking system based on shared interests.

The social networking may store data about its users and other objects using a social graph that includes nodes connected by edges. Nodes include users and objects of the social networking system, such as web pages embodying concepts and entities. Edges connect nodes and represent a particular interaction between the objects or users corresponding to the two nodes. For example, an edge indicates when a user expresses an interest in a news article shared by another user about “America's Cup.” Hence, the social graph records interactions between users of the social networking system as well as interactions between users and objects of the social networking system by storing information in the nodes and edges that represent these interactions.

Additionally, the social graph may include custom graph object types and graph action types defined by third-party developers as well as social networking system administrators of the social networking system. This allows third-party developers or administrators to define attributes of graph objects and graph actions. For example, a graph object for a movie may have several defined object properties, such as a title, actors, directors, producers, year, and the like. A graph action type, such as “purchase,” may be used by a third-party developer on a website external to the social networking system to report actions performed by users of the social networking system on the external website. This allows the social graph to be “open,” by allowing third-party developers to create and use the custom graph objects and actions on external websites.

Third-party developers may enable social networking system users to express interest in web pages or other content provided by websites external to the social networking system. For example, web pages may be represented as page objects in the social networking system by embedding a widget, a social plug-in, programmable logic or, a code snippet (e.g., an iframe) into the web pages. Hence, any concept that can be embodied in a web page may become a node in the social graph on the social networking system. This allows social networking system users to interact with objects external to the social networking system relevant to a keyword or keyword phrase, such as “Justin Bieber.” Each interaction with an object may be recorded by the social networking system as an edge, which may allow advertisers to target advertisements based on user interactions with objects related to a keyword. This allows the advertisements to reach a more receptive audience including users previously performing an action related to the advertisement. For example, a merchandiser that sells Justin Bieber t-shirts, hats, and accessories may target ads for new merchandise to users that have recently performed one or more specific actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is described further in U.S. application Ser. No. 13/239,340 filed on Sep. 21, 2011, which is hereby incorporated by reference in its entirety.

The social networking system may additionally or alternatively maintain a collection of claims made by users and entities of the social networking system. A claim, as stored as a data structure in the social networking system platform, includes multiple components. For example, a claim includes one or more of: an author, an owner, an assertion, an audience, copyrights, and metadata associated with the claim by the social networking system. A user may make a number of “claims” on a social networking system, such as having attended a certain college, working for a certain company, being raised in a certain location, or being friends with other users of the social networking system. Claims on a social networking system include other declared user profile information, such as where the user currently lives and other biographical information about the user, including the age, gender, hometown, dating interests, relationship status, languages spoken, religious beliefs, and political views, as well as other information, including contact information, work and education experience, family members, historical events posted to a timeline, and favorite quotes.

Claims may be “authored” by “agents” of the social networking system. Examples of an agent include such as users, entities, and applications authorized to act on behalf of an agent. An author agent may designate an “owner” to assign ownership of a claim. An owner agent may specify certain settings for a claim, such as whether the claim may be copied by other agents and whether the claim may be boosted in rankings by other agents. Each claim includes an “assertion” having a “payload” of content that is stored by the social graph. The payload of content is the core of an assertion. A claim may have a claim type; for example, a claim that a user currently lives in San Francisco has a claim type of “current city.” The claim type may be specified by a metadata object provided by the social networking system. The structure of claims is further discussed in U.S. patent application Ser. No. 13/455,047, filed on Apr. 24, 2012, hereby incorporated by reference in its entirety.

A social networking system may allow its users to generate structured queries for content that return objects (e.g., users, entities, and/or agents) of the social networking system. For example, a searching user may generate a query for “people nearby that are hungry and like Lady Gaga.” Rather than searching for content items that include the keywords “people,” “hungry,” and “Lady Gaga,” the social networking system may interpret the query as the searching user searching for other users (people) that are hungry (users that have recent status messages indicating hunger or lack of recent meal) and that have performed actions on the social networking system indicating an interest in Lady Gaga (song listen actions, posts about Lady Gaga, explicit declaration of interest in Lady Gaga, connected to a page for Lady Gaga, etc.). Hence, the social networking system may use machine learning and regression analysis to select objects for inclusion in the search results based on the searching user's query.

FIG. 1 illustrates a high-level block diagram of one embodiment of a process of managing privacy of user-generated lists in a social networking system. For example, a user 102 of a social networking system 100 generates a list on the social networking system 100 through a user interface provided by a list generation module 104. As another example, the social networking system 100 receives one or more user-generated lists through an application programming interface (API) provided by the list generation module 104, allowing a the user 102 to generate lists through mobile devices, external websites, or other applications connected to the API. Based on received information describing the list, a list object 110 is generated by the list generation module 104 and stored in a list store 106 in the social networking system 100.

A list privacy manager 108 provides the user 102 with one or more list privacy level options for the newly-generated list object 110, including a list privacy level limiting access to the list to the user 102, a list privacy level limiting access to the list to users identified by the list (“members” of the list), a list privacy level allowing any social networking system user to access the list. In one embodiment, the list privacy level may be specified as the list privacy level of another list. For purposes of illustration, FIG. 1 shows the list object 110 as including object A 112a, object B 112b, and object C 112c. The user 102 may include any type of object maintained by the social networking system 100, such as users, entities, pages, applications, places, content items, and other objects in a list object 110.

FIG. 1 and the other figures use like reference numerals to identify like elements. A letter after a reference numeral, such as “112a,” indicates that the text refers specifically to the element having that particular reference numeral. A reference numeral in the text without a following letter, such as “112,” refers to any or all of the elements in the figures bearing that reference numeral (e.g. “112” in the text refers to reference numerals “112a,” “112b,” and/or “112c” in the figures). For purposes of illustration, three objects 112 are shown in FIG. 1, although any number of objects may be included.

In the example of FIG. 1, the list privacy manager 108 includes a privacy analysis module 114, a notification module 116, and a publishing module 118. The privacy analysis module 114 determines the list privacy level set for a list object. The notification module 116 provides notifications to members of a list that they have been added to a user-generated list based on the list privacy level. If the list privacy level limits access to the list object to the creating user, no notifications are sent to the members of the list. If the list privacy level allows members of the list to access the list or allows any social networking system to access the list object 110, notifications are sent to the members upon being added to the list. In one embodiment, the publishing module 118 provides a user interface to the user 102 for publishing content items to the list. In another embodiment, the publishing module 118 publishes content items based on the list privacy level of an identified list object 110. For example, a user 102 publishes a content object 122 and sets the privacy level of the content item to the list privacy level of a stored list object 110. The publishing module 118 then publishes the content object 122 to users satisfying the list privacy level of the stored list object 110. For example, if the stored list object 110 selected by a user 102 has a list privacy level limiting access to members of the list, the content item has a privacy level limiting access to the content item 122 to members of the stored list object 110 selected by the user. Hence, in this example additional objects 120, such as additional users, are unable to view the content object 122 unless they are included in the list represented by the stored list object 110.

### System Architecture

FIG. 2 is a high level block diagram of one embodiment of a system environment suitable for claims-based querying in an online system, such as the social networking system 100. The system environment shown by FIG. 2 comprises one or more user devices 202, the social networking system 100, a network 204, and external websites 212. In alternative configurations, different and/or additional modules can be included in the system.

The user devices 202 comprise one or more computing devices for receiving user input as well as transmitting and/or data via the network 204. In one embodiment, the user device 202 is a conventional computer system executing, such as a desktop or laptop computer. Alternatively, the user device 202 may be a device having computer functionality, such as a personal digital assistant (PDA), mobile telephone, smart-phone, or another suitable device.

A user device 202 is configured to communicate via network 204. For example, the user device 202 executes an application, such as a browser application, allowing a user of the user device 202 to interact with the social networking system 100. Alternatively, the user device 202 interacts with the social networking system 100 through an application programming interface (API) running on a native operating system of the user device 202, such as IOS® or ANDROID™.

In one embodiment, the network 204 uses standard communications technologies and/or protocols. Thus, the network 204 may include communication channels using technologies such as Ethernet, 802.11, worldwide interoperability for microwave access (WiMAX), 3G, 4G, code division multiple access (CDMA), digital subscriber line (DSL), or any other suitable technology. Similarly, the networking protocols used on the network 204 may include multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). The data exchanged over the network 204 may be represented using technologies and/or formats including the hypertext markup language (HTML) and the extensible markup language (XML). In addition, all or some of the communication channels may be encrypted using conventional encryption technologies such as secure sockets layer (SSL), transport layer security (TLS), and Internet Protocol security (IPsec).

FIG. 2 includes a block diagram of one embodiment of the social networking system 100. The social networking system 100 includes a node store 206, a web server 208, a content store 214, an action logger 210, a list store 106, a list generation module 104, and a list privacy manager 108. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 to one or more user devices 202 via the network 204; the web server 208 serves web pages, as well as other content, such as JAVA®, FLASH®, XML, and so forth. The web server 208 may receive and route messages between the social networking system 100 and the user devices 202. In various embodiments, the messages may be instant messages, queued messages (e.g., email), text and short message service (SMS) messages, or messages sent using any other suitable messaging technique. The user may send a request to the web server 208 to upload information, for example, images or videos that are stored in the claim store 206. Additionally, the web server 208 may provide application programming interface (API) functionality to send data directly to native user device operating systems, such as IOS®, ANDROID™, or RIM®. For example, a user may create a check-in event at a coffee shop in San Francisco, Calif. that is shared with other users connected to the user.

The action logger 210 receives communications from the web server 208 about user actions internal to or external to the social networking system 100. Based on the received communications the action logger 210 populates an action log with information about user actions. Examples of user actions include adding a connection to another user, sending a message to another user, uploading an image, reading a message from another user, viewing content associated with another user, attending an event created by another user, among others. In addition, a number of actions described in connection with other objects are directed at particular users, so these actions are also associated with those users.

An action log may be used by a social networking system 100 to log users' actions on the social networking system 100 as well as on external websites 212 that communicate information back to the social networking system 100. Information communicated to the social networking system 100 from an external website 212 is limited by users' privacy settings; additionally, user identifying information provided to external websites 212 for identifying users may be hashed or otherwise anonymized. Hence, the action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were accessed, purchasing activity, and other patterns from shopping and buying.

User account information and other related information for a user are stored as user profiles in the node store 206. The user profile information stored in node store 206 describes the users of the social networking system 100, including biographic, demographic, and other types of descriptive information, such as work experience, educational history, gender, hobbies or preferences, location, and the like. A user profile may also include other information provided by the user, for example, images or videos. In certain embodiments, images of users may be tagged with information identifying users of the social networking system 100 displayed in an image. The node store 206 also maintains references to the actions stored in an action log and performed by users on objects in the content store 214.

The node store 206 may also store edge information describing connections between users and other objects on the social networking system 100. Some edges may be defined by users, allowing users to specify their relationships with other users. For example, edges are generated when users express interest in a page on the social networking system 100, share a link with other users of the social networking system 100, or comment on posts made by other users of the social networking system 100.

Information describing edges and stored by the node store 206 includes such as affinity scores for objects, interests, and other users. Affinity scores may be computed by the social networking system 100 over time to approximate a user's interest for an object, interest, and other users in the social networking system 100 based on the actions performed by the user. Multiple interactions between a user and a specific object may be stored as a single edge in the node store 206, in one embodiment. For example, a user that plays multiple songs from Lady Gaga's album, “Born This Way,” may have multiple edges for the songs, but a single edge for Lady Gaga.

The content store 214 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 214, such as status updates, photos tagged by users to be associated with other objects in the social networking system, events, groups or applications. In some embodiments, objects are received from third-party applications or third-party applications separate from the social networking system 100. In one embodiment, objects in the content store 214 represent single pieces of content, or content “items.” Hence, users of the social networking system 100 are encouraged to communicate with each other by posting text and content items of various types of media through various communication channels. This increases the amount of interaction of users with each other and increases the frequency with which users interact within the social networking system 100.

As described above in conjunction with FIG. 1, the list generation module 104 receives selections of objects for inclusion in a list from a social networking system user. The list generation module 104 may receive selections of objects from any suitable source, such as a social plugin, an iframe, a desktop application a, native mobile application, a web browser application, or any other suitable source. As described above in conjunction with FIG. 1, the list privacy manager 108 allows a user to associate a list privacy setting with a created list to specify the access of other social networking system users to the created list.

### Using Privacy of User-Generated Lists for Publishing Content on a Social Networking System

FIG. 3 illustrates a flow chart of one embodiment a process for publishing content in a social networking system 100 using privacy levels based on user-generated lists. The social networking system 100 receives 302 a content item from a user and receives a privacy setting associated with the content item identifying a stored list. For example, the content item is received 302 through a user interface presented by a user device 202 on a user device connected to the social networking system 100 via the network 204. As another example, the content item is received 302 from a user interface presented by a system external to the social networking system, such as an external website 212. However, the content item may be received 302 through any suitable interface or through any suitable communication channel, such as an application programming interface.

The list identified by the privacy setting of the content item is retrieved 304 from the list store 106 or another suitable source from the social networking system 100. The list privacy level of the suitable source list is determined 306. For example, a list object or other data representing the identified list is analyzed to determine 306 the privacy level of the list. As described above, the list privacy level may limit access to the list to the user that created the list, limit access to the list to users identified by the list (“members” of the list), or allow any social networking system user to access the list. Additionally, the list privacy level may be set to the list privacy level of an additional list, so the list privacy level of the additional list is determined. In some embodiments, the list privacy level of the identified list may be set to multiple lists, so the list privacy level of the identified list includes members of the multiple lists.

The privacy level of the content item is then determined 308 to be the list privacy level of the identified list. In one embodiment, the privacy level setting of the content item is a reference to the list object representing the list in the social networking system 100. In another embodiment, the privacy level of the content item is specified as the current members of the list object. In a further embodiment, the content item is accessible to each member of the identified list. Based on the determined privacy level, the content item is provided 310 to one or more users with access to the content item.

FIG. 4 illustrates an example screenshot of an interface for managing privacy for user-generated lists in a social networking system. In FIG. 4, a list generating user interface 400 is displayed that includes an interactive title bar 402. In this example, the user has created a list titled, “People who like Lady Gaga.” The user interface 400 indicates that the list includes several members 404, 406, 408, and 410 that are users of the social networking system 100. In other embodiments, user-generated lists may include pages that represent people as well as other agents, applications, and other objects maintained by the social networking system 100. The list generating user interface 400 also includes a prompt 412 for the user to add itself to the list. Additionally, the list generating user interface 400 includes a prompt 414 for the user to add one or more other users to the list. Interface elements 424 and 426 may also be used to add the list generating user and one or more other users to the list.

The list generating user interface 400 also includes several interface elements 416, 418, 420, and 422 for members 404, 406, 408, and 410 of the list. The interface elements 416, 418, 420, and 422 allow a user to remove a member 404, 406, 408, and 410 from the list. In one embodiment, the social networking system 100 may identify members 404, 406, 408, and 410 for inclusion in the list based on characteristics of users and characteristics associated with the title of the list. For example, a user may query the social networking system 100 for “People who like Lady Gaga” and save the search results as a list. Structured queries in a claims-based online system are further discussed in U.S. patent application Ser. No. 13/800,679, filed on Mar. 13, 2013, hereby incorporated by reference in its entirety.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a content item from a user for presentation to one or more users of a social networking system;
receiving a privacy setting associated with the content item, the privacy setting identifying a list of users of the social networking system;
retrieving the list of users identified by the privacy setting;
determining a list privacy setting associated with the list of users, the list privacy setting identifying users of the social networking system authorized to access the list; and
presenting the content item to users of the social networking system identified by the list privacy setting associated with the list of users authorized to access the list.

2. The method of claim 1, wherein the list privacy setting is selected from a group consisting of a setting limiting access to the list to a user that created the list, a setting limiting access to the list to users included on the list, and a setting allowing any user of the social networking system to access the list.

3. The method of claim 1, wherein the list privacy setting identifies an additional list of users of the social networking system user.

4. The method of claim 1, wherein the list privacy setting identifies users of the social networking system included on a plurality of additional lists of users.

5. The method of claim 1, further comprising:
receiving a request to include an additional user to the list of users; and
transmitting a notification to users identified by the list of users of the inclusion of the additional user to the list of users subject to the list privacy setting.

6. A method comprising:
receiving a content item from a user for presentation to one or more users of a social networking system;
receiving a privacy setting associated with the content item, the privacy setting identifying a list of objects maintained by the social networking system;
retrieving the list of objects identified by the privacy setting;
determining a list privacy setting associated with the list of objects, the list privacy setting identifying objects maintained by the social networking system authorized to access the list; and
presenting the content item so that the content item is accessible to objects identified by the list privacy setting.

7. The method of claim 6, wherein the list privacy setting is selected from a group consisting of a setting limiting access to the list to a user that created the list, a setting limiting access to the list to objects included on the list, and a setting allowing any object maintained by the social networking system to access the list.

8. The method of claim 6, wherein the list privacy setting identifies an additional list of objects maintained by the user.

9. The method of claim 6, wherein the list privacy setting identifies objects maintained by the social networking system included on a plurality of additional lists of objects.

10. The method of claim 6, wherein an object maintained by the social networking system is selected from a group consisting of: a user, a page, an application, a content item, a place, and any combination thereof.

11. A method comprising:
receiving a content item from a user for presentation to one or more users of a social networking system, the content item associated with a list of objects authorized to access the content item;
retrieving the list of objects associated with the content item;
determining a list privacy setting associated with the list of objects and identifying objects maintained by the social networking system authorized to access the list; and
presenting the content item to objects identified by the list privacy setting as authorized to access the list.

12. The method of claim 11, wherein the list privacy setting is selected from a group consisting of a setting limiting access to the list to a user that created the list, a setting limiting access to the list to objects included on the list, and a setting allowing any object maintained by the social networking system to access the list.

13. The method of claim 11, wherein the list privacy setting identifies an additional list of objects maintained by the user.

14. The method of claim 11, wherein the list privacy setting identifies objects maintained by the social networking system included on a plurality of additional lists of objects.

15. The method of claim 11, wherein an object maintained by the social networking system is selected from a group consisting of: a user, a page, an application, a content item, a place, and any combination thereof.
